(19) United States
(12) Patent Application Publication
(10) Pub. No.: US 2004/0006447 A1
(43) Pub. Date: Jan. 8, 2004

(54) Methods and apparatus for test process enhancement

(76) Inventor: Jacky Gorin, Scottsdale, AZ (US)

Correspondence Address: PHOENIX TECHNOLOGY LAW GROUP, LLC, BOX 258, 3370 NORTH HAYDEN ROAD, NO. 123, SCOTTSDALE, AZ, 85257, US

(21) Appl. No.: 10/401,495

(22) Filed: Mar. 28, 2003

Related U.S. Application Data
(63) Continuation-in-part of application No. 09/888,104, filed on Jun. 22, 2001, now abandoned.
(63) Continuation-in-part of application No. 09/821,903, filed on Mar. 29, 2001, now abandoned.
(60) Provisional application No. 60/392,196, filed on Jun. 28, 2002.
(60) Provisional application No. 60/234,213, filed on Sep. 20, 2000.
(60) Provisional application No. 60/213,335, filed on Jun. 22, 2000.

(51) Int. Cl. G06F 15/00; G06F 17/18; G06F 101/14

(52) U.S. Cl. 702/181

(57) ABSTRACT

A method and apparatus for enhancing a test process according to various aspects of the present invention includes analyzing test data and generating recommendations for enhancing the test process. Generally, an exemplary test system comprises an analyzing system for analyzing test data generated by the test process and a recommendation system for recommending enhancements to the test process based on the analysis. The exemplary system is configured to generate characteristic values, such as process control statistics, based on raw test data. The method and apparatus may also analyze test data that has been filtered to remove selected types of data, such as outliers, failures, and/or missing data. Further, the analysis may classify the various tests according to the characteristic values. In addition, the analysis may identify correlations between various tests based on at least one of the raw test data and the filtered test data. The recommendation system suitably recommends enhancements according to the classification of the tests. The tests may be modified accordingly.

### CROSS-REFERENCES TO RELATED APPLICATIONS

This application claims the benefit of U.S. Provisional Patent Application No. 60/392,196, filed Jun. 28, 2002; is a continuation-in-part of U.S. Nonprovisional Patent Application Serial No. 09/888,104, filed on Jun. 22, 2001, which claims the benefit of U.S. Provisional Patent Application No. 60/234,213, filed Sep. 20, 2000; and is a continuation-in-part of U.S. Nonprovisional Patent Application No. 09/821,903, filed Mar. 29, 2001, which claims the benefit of U.S. Provisional Patent Application No. 60/213,335, filed Jun. 22, 2000, and incorporates the disclosure of each application by reference.

### FIELD OF THE INVENTION

The invention relates to methods and apparatus for testing devices.

### BACKGROUND OF THE INVENTION

Modern large-scale electronic device testing employs automatic test equipment (ATE) to control product quality and promote manufacturing integrity. ATE provides fast, flexible testing solutions for testing different types of devices without significantly altering the hardware. Generally, ATE applies input signals to the terminals of the electronic devices, measures the response at the output terminals, classifies the device, and stores the results.

To accommodate different types of devices, the ATE executes different test programs designed for the particular type of device. The test program controls the signals, such as magnitude and frequency, applied to the input terminals of the devices under test and the measurements of the output response from the device. The test program may also control other conditions, such as heat applied to the device for testing. A test program for a particular device may apply hundreds of different tests to a particular device, each test designed to verify the operability of the device.

Preparing a test process is a complex task requiring considerable experience. The test process should fully test the device and determine whether the test results indicate proper operation of the device. Consequently, the test process should apply a wide range of test signals to the various inputs of the device, read a wide range of output signals from the output terminals, and properly analyze the output signals to determine whether the response from the device was acceptable. As devices have grown more complex, so too have the test processes become extremely complex and difficult to manage. Similarly, the test process has become longer as the tests have become more numerous. Longer tests delay the production process and consequently cost more.

### BRIEF SUMMARY OF THE INVENTION

A method and apparatus for enhancing a test process according to various aspects of the present invention includes analyzing test data and generating recommendations for enhancing the test process. Generally, a test system according to various aspects of the present invention comprises an analyzing system for analyzing test data generated by the test process and a recommendation system for recommending enhancements to the test process based on the analysis.

In an exemplary embodiment, the method and apparatus is configured to generate characteristic values based on the test data, such as process control statistics, on raw test data. The method and apparatus may also analyze test data that has been filtered to remove selected types of data, such as outliers, failures, and/or missing data. Further, the analysis may classify the various tests according to the characteristic values. In addition, the analysis may identify correlations between various tests based on at least one of the raw test data and the filtered test data. The recommendation system suitably recommends enhancements according to the classification of the tests. The tests may be modified accordingly.

### BRIEF DESCRIPTION OF THE DRAWINGS

A more complete understanding of the present invention may be derived by referring to the detailed description and claims when considered in connection with the following illustrative figures. In the following figures, like reference numbers refer to similar elements and steps throughout the figures.

FIG. 1 is a block diagram of a test system according to various aspects of the present invention;

FIG. 2 is a block diagram of a test method and apparatus according to various aspects of the present invention;

FIG. 3 is a general flow diagram of a test enhancement method and apparatus according to various aspects of the present invention;

FIG. 4 is a flow diagram of a characteristic value calculation process;

FIGS. 5A-B are flow diagrams of a filtering process;

FIG. 6 is a flow diagram of a test classification process based on characteristic values;

FIG. 7 is a flow diagram of a correlation value calculation process;

FIG. 8 is a flow diagram of a process for identifying related and/or redundant tests based on correlation values;

FIG. 9 is a flow diagram of a process for generating recommendations based on characteristic values and correlations; and

FIG. 10 is a flow diagram for recommending a test for removal.

Elements and steps in the figures are illustrated for simplicity and clarity and have not necessarily been rendered according to any particular sequence. For example, steps that may be performed concurrently or in different order are illustrated in the figures to help to improve understanding of embodiments of the present invention.

### DETAILED DESCRIPTION OF EXEMPLARY EMBODIMENTS

The present invention is described partly in terms of functional block components and various processing steps. Such functional blocks may be realized by any number of hardware or software components configured to perform the specified functions and achieve the various results. For example, the present invention may employ various machines, processors, integrated circuit components, software modules, and/or process steps, e.g., statistical engines, memory elements, signal elements, logic elements, look-up tables, and the like, which may carry out a variety of functions under the control of one or more testers, microprocessors, or other control devices. In addition, the present invention may be practiced in conjunction with any number of statistical processes and analyses, and the system described is merely one exemplary application for the invention. Further, the present invention may employ any number of conventional techniques for data analysis, component interfacing, data processing, and the like.

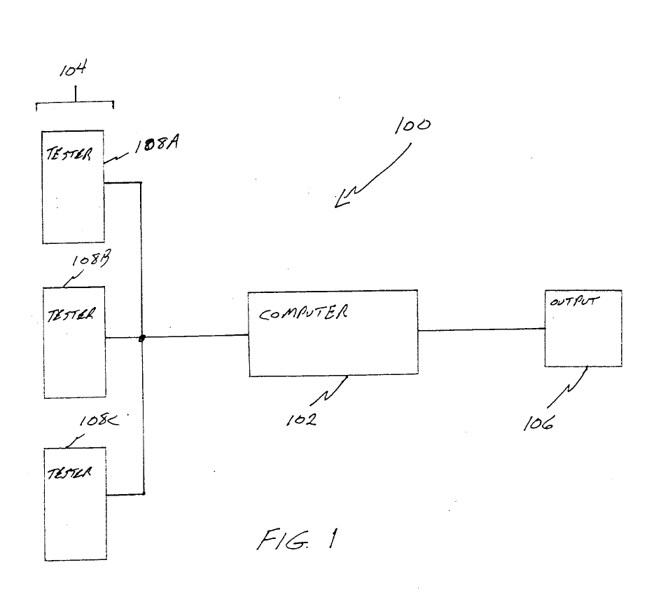

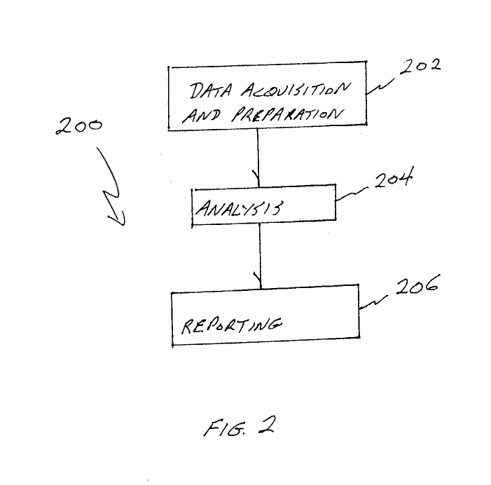

Referring to FIG. 1, a test enhancement method and apparatus 100 according to various aspects of the invention may be implemented in conjunction with a program operating on a computer 102. The computer 102 communicates with a data source 104, which provides a set of test data. The test enhancement method and apparatus 100 also suitably include an output 106 for transmitting information, such as transmitting test enhancement recommendations and/or corrections. The test enhancement method and apparatus 100 are suitably configured to analyze test data from the data source 104 and automatically provide recommendations and/or corrections for enhancing the test process.

The test enhancement method and apparatus may be implemented in any suitable environment, such as chemical processing, product manufacturing, quality control, or any other environment having multiple samples. In the present embodiment, the test enhancement method and apparatus 100 are implemented in a semiconductor testing environment. The data source 104 may comprise any suitable source of data for analysis, such as one or more automatic testers 108A-C. In addition, the data source 104 may comprise different testers on the same test floor, in different parts of the facility, or in different parts of the world. Thus, the test enhancement system may be used for test enhancement for individual testers, multiple testers, complete facilities, or a worldwide testing program.

The testers 108A-C test multiple components in conjunction with a test program, which controls the tests applied by the testers 108A-C to the components. As the components are tested, the testers 108A-C monitor the results of the tests, and store the test data. The test results may be received from any stage of the fabrication or distribution process, such as wafer test, final test, or pre-installation test. The test data is provided to the computer 102. The test data is provided by the data source 104 in any appropriate form, such as conventional standard test data format (STDF). In addition, the test data may comprise any suitable test data, such as parametric and/or functional test data. In the present embodiment, the test enhancement method and apparatus utilizes parametric test data, though the test system may be configured for functional test data as well.

The test data may be contemporaneously provided from the data source 104 upon generation, or may be provided to the computer 102 at any later time, for example by storing the test data and providing the test data to the computer 102 later. The computer 102 is illustrated in FIG. 1 as being coupled directly to the data source 104, but the computer 102 may be in a different room, different facility, or at any remote location. In addition, the computer 102 may receive the test data according to any appropriate transmission medium and technique, for example transfer via disk, remote transmission, download, and the like. Further, the computer 102 may analyze the test data at any time, such as upon generation of the test data by the tester 108A-C or offline while the tester 108A-C is shut down or performing different operations. Any amount of test data may be provided to the computer 102. Larger amounts of data tend to provide greater accuracy in analysis, but smaller amounts may be suitable for some situations, such as in operability verification or ramp-up cases.

The computer 102 may comprise any suitable system for analyzing the test data and generating enhancement recommendations and/or corrections. For example, the computer 102 suitably comprises a conventional personal computer or workstation having a processor and a memory. The computer 102 uses the test data from one or more testers 108A-C to generate the test enhancement recommendations and/or corrections.

The computer provides the test enhancement recommendations and/or corrections via the output 106. The output 106 may comprise any appropriate interface for communicating the test enhancement recommendations and/or corrections, such as a conventional storage system, printer, monitor, transmission system for sending the test enhancement recommendations and/or corrections to an interested party, or any other suitable system for providing the test enhancement recommendations and/or corrections.

To generate the test enhancement recommendations and/or corrections, the computer 102 analyzes the test results in conjunction with an automatic test process enhancement system. In the present embodiment, the automatic test process enhancement system is implemented, at least in part, as a test enhancement computer program executed by the computer 102, although the system may be implemented in any suitable manner or environment, such as a test methodology, a hardware implementation, multiple software and/or hardware elements operating on multiple computers, or on a microprocessor integrated into the tester 108. The computer 102 receives the test data from the data source 104, analyzes the test data, and generates the test enhancement recommendations and/or corrections at the output 106 according to the automatic test process enhancement system.

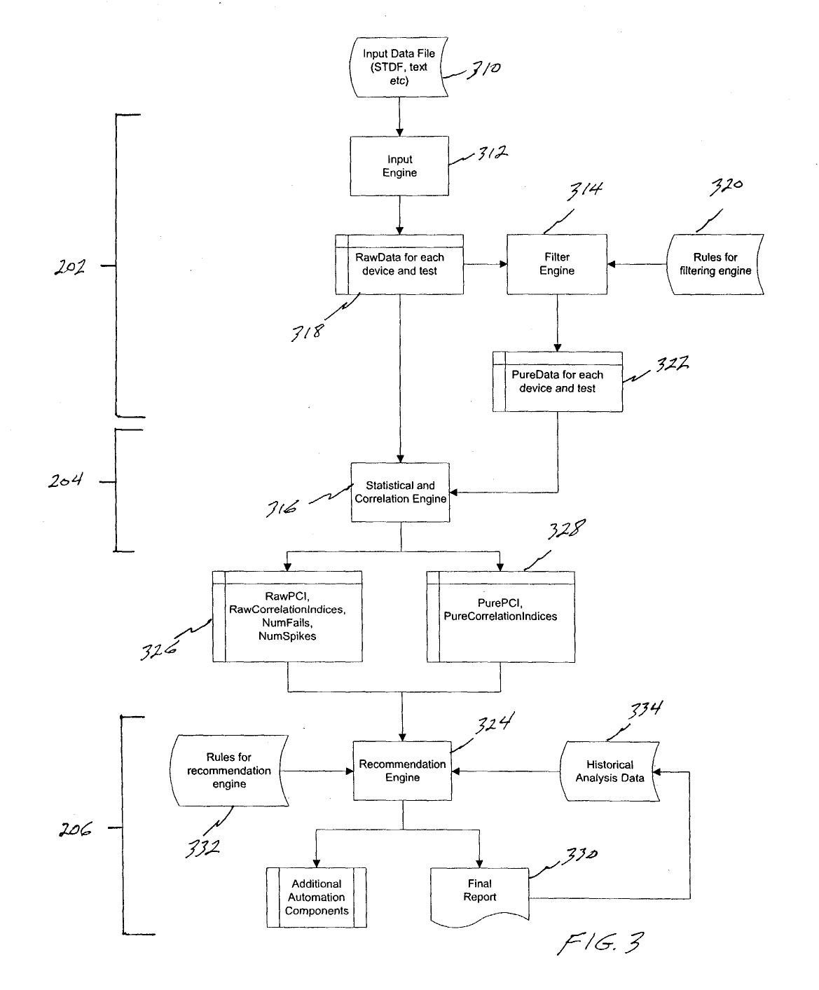

The automatic test process enhancement system may be configured in any appropriate manner to generate the test enhancement recommendations and/or corrections. For example, the automatic test process enhancement system may be implemented as a single continuous process, multiple modules or systems operating in stages, or multiple devices or programs operating on one or more computers. Referring to FIG. 2, in the present embodiment, an automatic test process enhancement system 200 according to various aspects of the present invention may be considered as having a data acquisition and preparation component 202, an analysis component 204, and a reporting component 206. These components may not represent actual divisions or modules of the automatic test process enhancement system, but facilitate description of the present test enhancement computer process 200.

The data acquisition and preparation component 202 prepares the tester data for analysis, for example by organizing the data for analysis and calculating supplementary information for analysis. The analysis component 204 analyzes the data, including the data from the data acquisition and preparation component 202. The reporting component 206 responds to the analysis component 204 to provide the test enhancement recommendations and/or corrections.

More particularly, in the present embodiment, the data acquisition and preparation component 202 is configured to receive the test data from the data source 104, and any other relevant data, for analysis. The data acquisition and preparation component 202, however, may comprise any suitable system for receiving the data and preparing the data for analysis. The data acquisition and preparation component 202 is also suitably configured to organize the data and perform various initial tasks and/or calculations to facilitate analysis. The data acquisition and preparation component 202 may also acquire supplemental data to facilitate preparation and analysis, such as control limits, outlier parameters to identify outliers in the tester data, user-specified or default parameters, or other relevant information. Supplemental data may be acquired from any appropriate source, such as a memory, a storage device, calculations, or a remote system. Various data may be specified as default values that may be modified by the user.

Referring to FIG. 3, the present exemplary data acquisition and preparation component 202 suitably includes an input engine 312 and a filter engine 314. The input engine 312 receives and organizes data. The filter engine 314 analyzes the data for anomalies, such as statistical outliers and failures, and suitably generates a filtered set of test data without the anomalies.

More particularly, the input engine 312 is suitably configured to initially receive and store the tester data 310. In the present embodiment, tester data is received in conventional STDF format. The input engine 312 suitably generates an organized set of raw test data 318 for every device and test. For example, the input engine may organize tester data 310 into a format to facilitate analysis. In the present embodiment, the input engine 312 organizes the tester data 310 to facilitate analysis, such as in a table format having a device dedicated to each row and a test for each column, a wafermark format, or any other format to facilitate analysis. The resulting raw test data 318 may then be provided for use by other elements of the system, such as the filter engine 314 and the statistical and correlation engine 316.

The filter engine 314 generates a filtered set of test data 322. The filter engine 314 may be configured to filter data having or lacking any selected characteristics from the raw set of data. For example, the filter engine 314 may be configured to remove statistical outliers, instances of missing data, and/or failures from the raw set of data. In addition, in various embodiments, the filter engine 314 may not be necessary and, consequently, may be omitted.

The filter engine 314 may operate according to any suitable criteria, such as criteria automatically selected or generated according to the test data or preselected criteria. For example, in the present embodiment, the filter engine 314 may operate in conjunction with a set of rules that may be specified by the operator or automatically selected. The set of rules to be used may be selected from a library of multiple predefined rule sets adapted for different types of data, testers, preferences, or other conditions or criteria.

In the present embodiment, the filter engine 314 receives rules 320 for the filtering process. The rules 320 may comprise any appropriate rules or guidelines for filtering selected data from the raw data set, such as outlier thresholds, control limits, or characteristics associated with particular data for filtering. For example, the present filter engine 314 receives criteria for designating missing data and dynamically calculating outlier thresholds for identifying outliers in the test data.

Outlier thresholds may be selected according to any suitable criteria or system, such as defined values, values specified by or derived from user-provided data, or according to a statistical algorithm. In the present embodiment, the upper and lower outlier thresholds may be calculated by multiplying a baseline factor, such as approximately 1.5 or other suitable value, by the inter-quartile range for the data associated with the test. The resulting value may be added to the upper quartile value and subtracted from the lower quartile value to generate the upper and lower outlier thresholds, respectively. Any appropriate rules, recipes, and/or procedures may be applied, however, to identify data to be filtered.

Upon calculation or receipt of the relevant thresholds or other data, the filter engine 314 suitably analyzes each test result in the test data. In the present embodiment, the filter engine 314 compares the test result in the test data with the upper and lower outlier thresholds, as well as one or more control limits used to determine whether the device passed, failed, or was otherwise qualified by the test. The thresholds may comprise any appropriate thresholds, and may be calculated, retrieved, or otherwise acquired from any appropriate source. In addition, if no data was provided for the particular test and device, the data set is so designated to indicate the missing data.

The filter engine 314 also suitably generates the filtered data set 322. To generate the filtered data set 322, the filter engine suitably filters the raw test data set 318 to remove selected data, for example data that may obscure relevant information in the remaining data. For example, the filter engine 314 may remove data corresponding to outliers, failures, missing data, or other data.

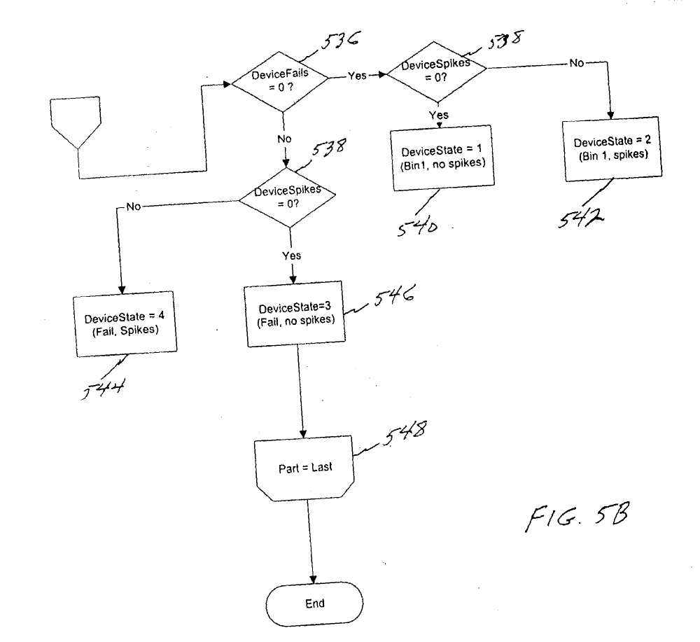

In the present embodiment, the filter engine 314 removes the outliers, failures, and the missing data in accordance with the rules for the filtering engine 320. In particular, referring to FIGS. 5A-B, the filter engine 314, for each device to be tested (510) and for each test upon the device (512), reviews each raw data entry for the presence of valid data (514). If no valid data is present, the data entry is designated as having missing data (516). In addition, the filter engine checks the standard deviation for each test (518). If the standard deviation is zero, then the filter engine 314 terminates any calculations that may require division by the standard deviation (520).

If the data is present and the standard deviation is not zero, the filter engine 314 may then determine whether the raw data exceeds either the control limits or the outlier threshold. For example, a delta figure may be calculated (522), such as by subtracting the median for the test data for the test from the raw test data value and dividing the result by the standard deviation (Delta=(Raw Value−Median)/SigmaFactor).

Outliers and failures are suitably identified by comparing the raw test data and the delta figures to the control limits and the outlier thresholds, respectively. Any appropriate rules, recipes, techniques, and/or procedures may be applied, however, to filter the data. In one embodiment, each raw test data entry is compared to the control limits (524). Any raw test data entry that is missing or surpasses the control limits is designated in the filtered data set as a failure (526). Similarly, the delta figure for each raw test data entry may be compared to the outlier threshold to identify spikes in the data (528). If the delta figure exceeds the outlier threshold, then the filtered data entry is designated as an outlier (530). If the raw data does not exceed the control limits and the delta figure does not exceed the outlier threshold, the filtered data is the same as the raw data (532). The process suitably repeats for each test performed on the device (534).

The filter engine 314 may also classify the device based on the filter process. For example, if no fails and no spikes occurred for the device (536, 538), the device may be classified as an acceptable device with no spikes (540). If no fails occurred but the tests results included spikes, the devices may be designated as acceptable but with spikes in the data (542). Likewise, if failures and spikes occurred, the device may be classified as having failures and spikes (544), and if failures occurred with no spikes, the device may be so designated (546). The process may be repeated for each device to be analyzed (548).

The filter engine 314 also suitably calculates additional data derived from the filtered test data 322 and the raw test data 318. In the present embodiment, the filter engine 314 determines the number of passed and failed tests for both the raw and filtered test data. The raw data set 318 and the filtered data set 322 and additional calculated data are suitably stored for use by the analysis component 204.

The analysis component 204 analyzes the data from the acquisition and preparation component 202 to provide test enhancement information. The analysis component 204 may perform any suitable analysis of the data to analyze and/or improve the test program, such as to identify critical and marginal tests (for example tests likely to cause failures or yield deviations), redundant tests, candidate tests suitable for sampling, and candidate tests for corrective action. For example, the analysis component 204 may classify tests into various categories and compare various values and statistics to support reports provided by the reporting component 206. The analysis component 204 may also perform any other appropriate analysis of the test data and supplementary data to support recommendations by the reporting component 206 or other desired function.

The analysis performed may be selected or generated according to any suitable objectives or preferences. For example, multiple analysis processes may be stored in a library for selective use by the analysis component 204. Various analysis processes may be selected automatically or by the operator according to any suitable criteria, such as the type of data, operator preferences, or other appropriate criteria. The analysis process may be implemented with a recipe for selecting desired parameters for the analysis.

For example, referring again to FIG. 3, the exemplary analysis component 204 of the present embodiment comprises a statistical and correlation engine 316. The statistical and correlation engine 316 calculates various statistics and figures to support recommendations and actions for test process enhancement. The values calculated by the statistical and correlation engine 316 may comprise any relevant values, such as figures based on the test data. For example, the statistical and correlation engine 316 may calculate a raw set of analysis results 326, such as a set of conventional statistical process control figures or other summary statistics for each test, such as standard deviation, Cpk, process capability indices, lower quartile, upper quartile, median, and inter-quartile range values based on the raw test data for the corresponding test. The statistical and correlation engine 316 may also calculate, for each test, a filtered set of analysis results 328 comprising “filtered” values of various relevant statistics, such as Cpk, process capability indices, lower quartile, upper quartile, median, and inter-quartile range values based on the filtered test data 322 for the corresponding test.

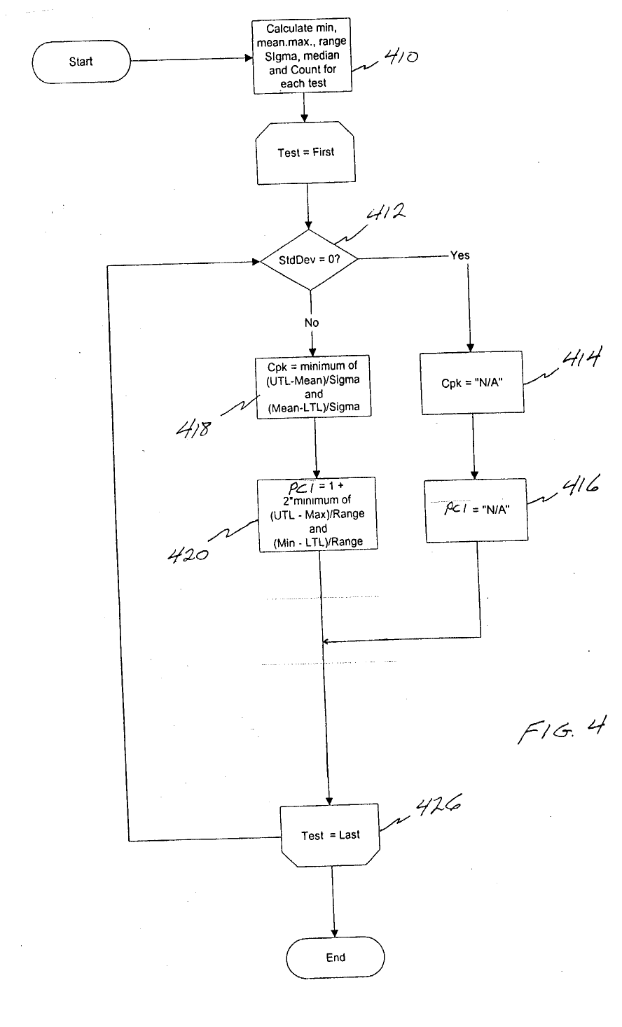

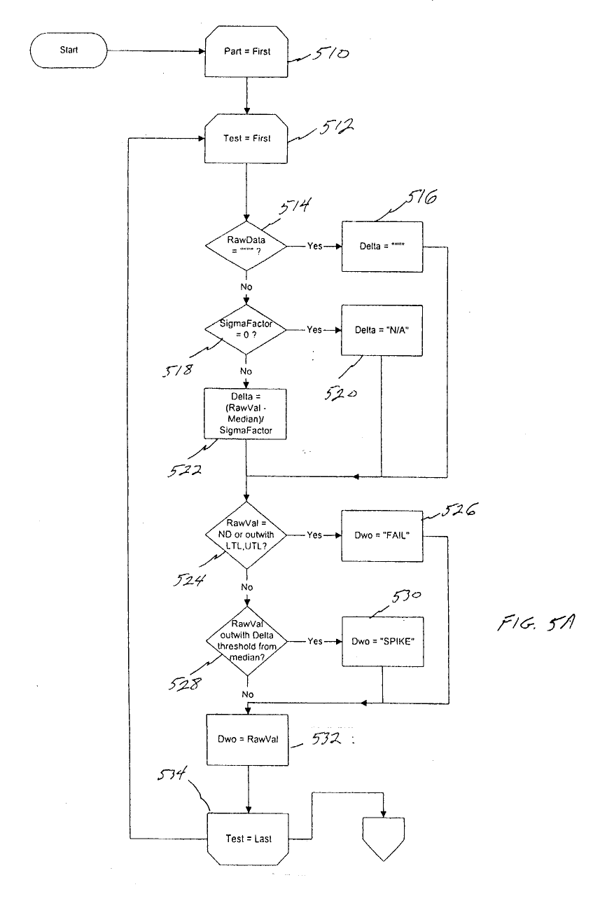

For example, referring to FIG. 4, the statistical and correlation engine 316 of the present embodiment initially calculates various characteristic values for the test data, such as the minimum, mean, maximum, range, standard deviation, median, and count, for each test (410). The statistical and correlation engine 316 may also calculate other characteristic values, such as the Cpk and a process capability index (PCI) for each test. If the standard deviation equals zero, then the data is not suitable for a Cpk and PCI analysis (412). Consequently, the Cpk and PCI values are designated as being unavailable (414, 416). If the standard deviation is not zero, then the statistical and correlation engine 316 determines the Cpk and PCI values according to a suitable algorithm. For example, in the present embodiment, the Cpk and PCI are determined according to the following equations (418, 420):

Cpk=the lesser of (UTL−Mean)/Sigma and (Mean−LTL)/Sigma

PCI=1+2*(the lesser of (UTL−Max)/Range and (Min−LTL)/Range)

where

UTL=upper test limit,

LTL=lower test limit,

Sigma=standard deviation,

Mean=the mean value of the data,

Max=the maximum value of the data,

Min=the minimum value of the data, and

Range=the range of the data.

The statistical and correlation engine 316 may then perform additional calculations for the particular test, if desired, or perform any other appropriate tasks to facilitate recommendations. The process may then repeat for each test (426).

The statistical and correlation engine 316 may also perform a correlation analysis to identify relationships between the various tests performed by the test process. Any appropriate analysis and algorithm may be used to determine whether tests are redundant or may be otherwise related. The correlation analysis is suitably performed for both the raw data set 318 and the filtered data set 322. The statistical and correlation engine 316 suitably generates correlation values for each test relative to every other test. The correlation analysis may support identification of linear and nonlinear correlations, and may be configured for parametric test data and/or functional test data.

The correlation values may be generated according to any suitable criteria or algorithm to identify relationships between the tests. In the present automatic test process enhancement system 200, correlations are identified according to the covariance of the test data for two particular tests and modified by the standard deviations for the two sets of test data. Thus, in the present system, correlation sets may be generated according to the following equations:

CorRawXY=Cov(RawX,RawY)/(RawSigmaX*RawSigmaY)

CorDwoXY=Cov(DwoX,DwoY)/(DwoSigmaX*DwoSigmaY)

for each test X and each test Y, where Dwo designates the filtered test data, Raw designates the raw data, Cov designates the covariance value, Sigma designates the standard deviation, and Cor designates the correlation value.

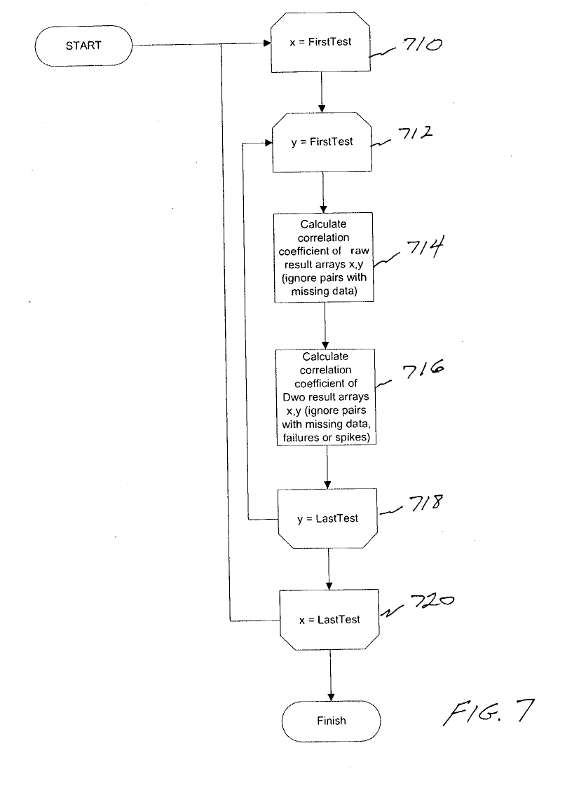

For example, referring to FIG. 7, a first test may be selected for correlation analysis against every other test (710). Another test is selected for the comparison (712), and the statistical and correlation engine 316 calculates the correlation values for the raw test data (714) and the filtered test data (716). For the raw correlation values, the statistical and correlation engine 316 disregards pairs having missing data. Similarly, for the filtered correlation values, the statistical and correlation engine 316 may disregard pairs having missing data, failures, or spikes. Another test is the selected for comparison to the first test, and the process is repeated for every remaining test (718). Upon completion of the correlation analysis for the first test, the process is repeated for every test (720), until every test has been analyzed for correlation with every other test.

The statistical and correlation engine 316 may provide the resulting figures and values in any appropriate form. In the present embodiment, the statistical and correlation engine 316 generates the raw set of analysis results 326, which suitably comprises the raw PCI, raw correlation values, number of failures, number of spikes, and any other relevant information based on the raw test data. The statistical and correlation engine 316 also suitably generates the filtered set of analysis results 328, which suitably comprises the filtered PCI, the filtered correlation values, and any other relevant information based on the filtered test data.

Referring again to FIGS. 2 and 3, the reporting component 206 receives data from the analysis component 204 and provides recommendations and/or corrections relating to the test process, which may then be acted upon by the user, implemented automatically, or otherwise utilized. In the present embodiment, the reporting component 206 identifies the portions of the test process that may benefit from corrective action, and may be configured to suggest one or more corrective actions. For example, a user may wish identify and eliminate redundant tests. Further, a user may wish to reconfigure a test that is marginal to improve yield. The reporting component 206 may also include or operate in conjunction with other reporting tools and systems.

In the present embodiment, the reporting component 206 provides the recommendations based only on the statistics and other values provided by the analysis component 204 based on common test data, without use of specialized test runs, the test data, or the test process itself. Recommendations and corrections may be generated, however, according to any appropriate criteria and/or data, including the test process, the test data, results from specialized test runs, or any other relevant information.

The reporting component 206 of the present embodiment includes a recommendation engine 324, which generates recommendations based on the statistics and figures. The recommendation engine 324 suitably makes recommendations for improving the test process. The recommendation engine 324 may make the recommendations according to any suitable rules 332 and data, such as the raw test data, filtered test data, the SPC values, PCI values, and/or selected algorithms. The recommendation engine 324 may also include historical analysis data 334, such as data from prior batches and the like, in the recommendation process.

In the present embodiment, the recommendation engine 324 classifies each test according to the raw set of analysis results 326 and the filtered set of analysis results 328. The classification may be performed according to any suitable data and/or criteria, such as correlation values, the number of test failures for the test, presence or absence of missing test data, raw and filtered PCI statistics, and number of outliers. The tests may be classified according to any suitable criteria to facilitate recommendations or corrective action.

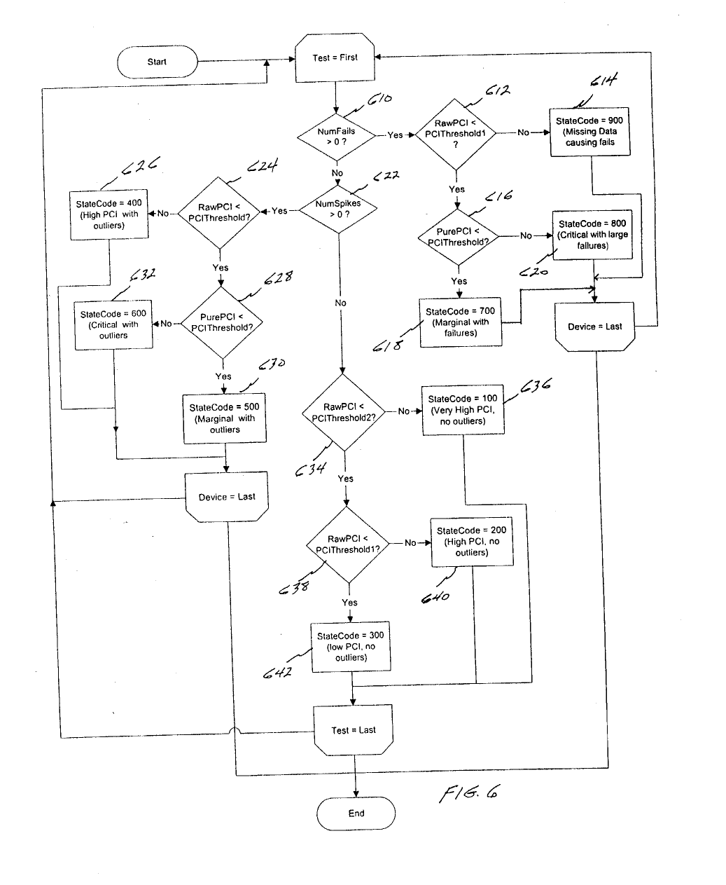

For example, referring to FIG. 6, the recommendation engine 324 of the present embodiment accesses data for a first test and determines whether any devices failed the test (610), i.e., any of the test data surpassed the control limits. If one or another selected number of failures occurred, the recommendation engine 324 may determine the cause of the failure according to any appropriate analysis. For example, the recommendation engine 324 may be configured to compare the raw PCI value to a first raw PCI threshold (612), which may be selected according to any suitable criteria, such as being provided as a default, by the user, or from another source or calculation. The first raw PCI threshold may be relatively low, such as 1.2, so that if the raw PCI value for the test surpasses the first raw PCI threshold, it indicates that missing data is causing the failures. The test is then assigned a corresponding state code based on the analysis, such as MISSING DATA CAUSING FAILS (900), indicating that missing data is causing the failures (614).

If the raw PCI value does not exceed the first raw PCI threshold, the recommendation engine 324 suitably classifies the test according to the PCI values for the test. For example, the filtered PCI value may be compared to a filtered PCI threshold (616). The filtered PCI threshold may similarly be selected, such as being provided as a default, by the user, or from another source or calculation, according to any suitable criteria. The test is then suitably assigned a corresponding state code to indicate that, according to the filtered PCI threshold comparison, the test results are marginal and include failures that failed by a relatively low margin (MARGINAL WITH FAILURES (700)) (618), or critical with failures that failed by a relatively high margin (CRITICAL WITH LARGE FAILURES (800)) (620).

If the initial determination indicates that no failures occurred or did not exceed the relevant threshold, then the recommendation engine 324 may determine whether any spikes were detected in the data (622). If so, then the recommendation engine 324 suitably classifies the test according to the PCI values for the test. For example, the recommendation engine 324 may compare the raw PCI value to the first raw PCI threshold (624), and if the first raw PCI threshold is exceeded, the test is classified as having a high PCI with outliers (HIGH PCI WITH OUTLIERS (400)) (626).

If the first raw PCI threshold is not exceeded, then the filtered PCI value may be compared to the filtered PCI threshold (628). The test is then suitably assigned a corresponding state code to indicate that, according to the filtered PCI threshold comparison, the test results are marginal and include outliers (MARGINAL WITH OUTLIERS (500)) (630), or critical with outliers (CRITICAL WITH OUTLIERS (600)) (632).

If the recommendation engine 324 determines that the test data does not include any outliers, then the recommendation engine 324 may further analyze the test data for classification. For example, in the present embodiment, the recommendation engine 324 compares the raw PCI value to a second, higher raw PCI threshold, which may be provided as a default, by the user, or from another source or calculation (634). If the raw PCI value exceeds the second raw PCI threshold, then the analysis component 204 assigns a state code to the test indicating that the test has a very high PCI with no outliers (VERY HIGH PCI, NO OUTLIERS (100)) (636).

If the raw PCI value does not exceed the second raw PCI threshold, the recommendation engine 324 compares the raw PCI value to the first raw PCI threshold (638), and assigns a state code to the test according to the comparison. If the filtered PCI value exceeds the threshold, then the analysis component assigns a state indicating that the test has a high PCI with no outliers (HIGH PCI, NO OUTLIERS (200)) (640), and if the threshold is not exceeded, then assigned state code indicates that the test has a low PCI with no outliers (LOW PCI, NO OUTLIERS (300)) (642).

In sum, the recommendation engine 324 of the present embodiment classifies the tests according to the presence of missing data, presence of failures, presence of outliers, and capability of the process according to the raw and filtered PCI values. The classification may be performed, however, according to any appropriate criteria and using any suitable data.

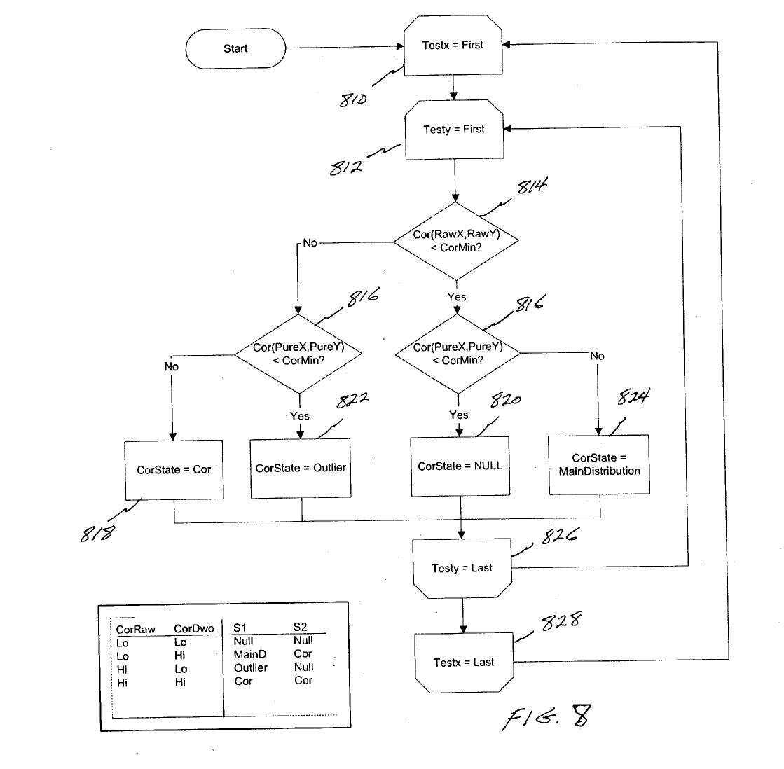

The analysis component 204 is also suitably configured to use the correlation values for the various tests relative to the other tests to support recommendations and/or corrections for the test process. The correlation values may be used in any suitable manner and according to any suitable criteria, such as to identify related and/or redundant tests. For example, referring to FIG. 8, the present recommendation engine 324 selects a first test (810) and a second test (812), and compares the raw correlation value for the two tests to a raw correlation threshold (814) and the filtered correlation value to a filtered correlation threshold (816). The correlation thresholds may be selected according to any suitable criteria to indicate the extent of the correlation, and may be provided by a default value, specified by the user, or otherwise acquired. In the present analysis component, the raw correlation threshold and the filtered correlation threshold are equal to each other.

The test correlations are suitably classified according to the comparisons of the correlation values to the correlation thresholds. For example, if both the raw and the filtered correlation values exceed the corresponding thresholds, then the correlation between the two tests is assigned a correlation state indicating that the tests correlate (818). If neither the raw nor the filtered correlation value exceeds the corresponding threshold, then the correlation between the two tests is assigned a correlation state indicating that the tests do not correlate (820).

If the raw correlation value exceeds the raw correlation threshold, but the filtered correlation value does not exceed the filtered correlation threshold, the outliers may be causing the appearance of a correlation that is not an actual correlation. Accordingly, the correlation between the two tests is assigned a correlation state indicating that the tests do not actually correlate, but the apparent correlation is caused by the outliers (822). Conversely, if the raw correlation value does not exceed the raw correlation threshold but the filtered correlation value does exceed the filtered correlation threshold, then the tests may correlate, but the outliers are obscuring the correlation. Thus, the correlation between the tests is assigned a corresponding correlation state (824).

The recommendation engine 324 then repeats the analysis for the first test compare to a third test, then a fourth, and so on until the correlation between the first test and every other test is classified (826). The recommendation engine 324 then repeats the process for every test to classify the correlation between each test and every other test (828).

Referring again to FIGS. 2 and 3, based on the classification of the tests, the reporting component 206 suitably generates a report 330 to provide recommendations for improving the test process. The report 330 may comprise any suitable information for improving the test process, such as the classification information based on the statistics and/or the correlation values or any other results of the analysis that may be useful for enhancing the test process. For example, the report may include supporting data, identification of correlations, and/or recommendations for eliminating or reconfiguring tests.

In the present embodiment, the recommendation engine 324 may be configured to generate recommendations by initially separating the tests according to state codes and making recommendations based on whether each test correlates to another test. For example, based on the state codes and the correlation data, the recommendation engine 324 may recommend that a particular test be performed for all devices, limited to sampling for fewer than all of the devices, considered for correction, or eliminated altogether. Based on these recommendations, the test process may be improved to reduce the overall test time, increase quality of the individual tests, enhance throughput, and/or otherwise improve the test process.

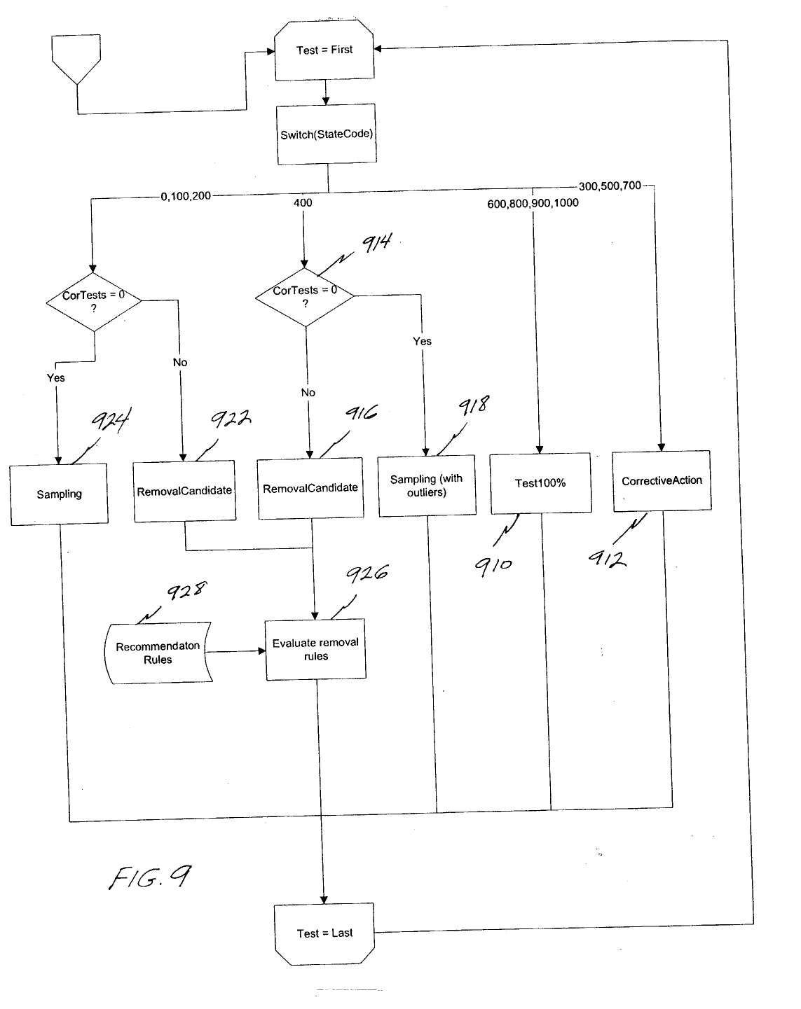

For example, referring to FIG. 9, the present recommendation engine 324 recommends that all tests having certain state codes be performed on every device (910). In particular, the recommendation engine 324 may recommend that each test having a binary result (i.e., YES/NO, ON/OFF, PASS/FAIL, etc.), which may correspond to state code 1000, and every test exhibiting a relatively high likelihood of failure and/or variation (i.e., critically low PCI or missing data causing fails) should be applied to every device. In the present embodiment, the recommendation engine 324 recommends for full testing every test having the state codes CRITICAL WITH OUTLIERS (600), CRITICAL WITH LARGE FAILURES (800), and MISSING DATA CAUSING FAILS (900).

Similarly, the present recommendation engine 324 recommends corrective action for tests having a low process capability index. In the present embodiment, for tests having state codes LOW PCI, NO OUTLIERS (300), MARGINAL WITH OUTLIERS (500), and MARGINAL WITH FAILURES (700), the recommendation engine 324 recommends corrective action (912). For example, corrective action may be required to change the test process to improve accuracy and/or repeatability, such as using a longer wait time for the signals to stabilize or implementing other corrective action. The recommendation engine 324 may be configured to identify tests that may benefit from corrective action. The recommendation 324 may also indicate possible corrective actions for selection by the operator.

For tests having the state codes VERY HIGH PCI, NO OUTLIERS (100) and HIGH PCI, NO OUTLIERS (200), the recommendation engine 324 determines whether the test correlates to another test (920). If so, the test is a candidate for removal (922), as the high correlation value indicates that the test is redundant. If not, because of the high PCI and absence of outliers, the test is unlikely to be failed by any component. Accordingly, the test may be recommended for sampling instead of 100% testing (924)

Similarly, for tests having state code HIGH PCI WITH OUTLIERS (400), the recommendation engine 324 determines whether the test correlates to another test (914). If so, the test is a candidate for removal (916). If not, the test may be recommended for sampling instead of 100% testing. In the present embodiment, the recommendation engine 324 indicates that the test is a candidate for sampling with the qualification that the test exhibits outliers (918). In certain cases, the user may wish, due to the presence of the outliers, to test every device with such a test to ensure quality. In other instances, the outliers may not be significant enough for the user to spend the time testing each and every component with the test, especially in view of the high capability rating of the test. Accordingly, as the test appears to exhibit sufficient capability and acceptably low failure rates, the test may be a candidate for sampling.

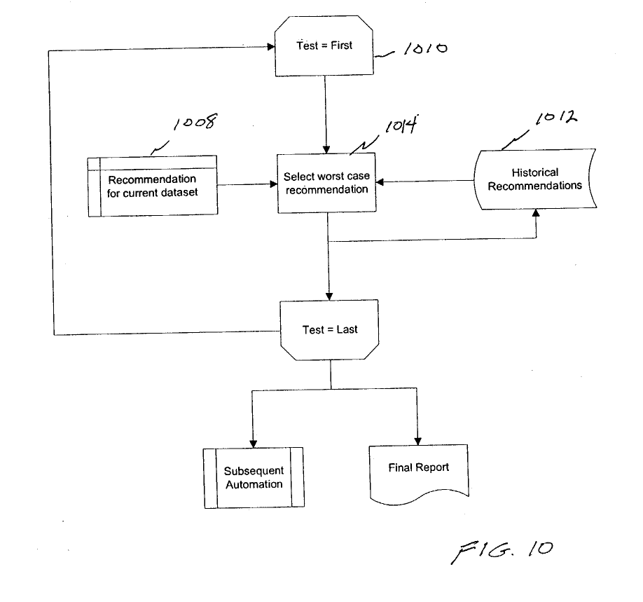

The recommendation engine 324 of the present embodiment generates recommendations according to the classification of the tests based on the statistics and the correlation values. The recommendations may be created, however, according to any appropriate criteria and using any suitable data. Referring to FIG. 10, in the present embodiment, the recommendation engine 324 may further analyze the initial recommendation in view of a series of historical recommendations. As each initial recommendation (1008) is initiated for each test (1010), the initial recommendation is stored in the historical recommendations data.

The recommendation engine 324 also checks the historical data to identify the recommendations previously made for the particular test (1012). The recommendation engine 324 may then modify the recommendation based on the historical data using any suitable criteria. In the present embodiment, the recommendation engine 324 selects the recommendation for maximum reliability based on the historical recommendations for the test (1014). For example, the historical data may indicate for a particular test that previous analyses have recommended removal of the test 90 times, sampling 20 times, and 100% testing just once; corrective action has never been recommended. In this case, for maximum reliability, the recommendation engine 324 may recommend 100% testing, even if the initial recommendation was for removal or sampling.

For the tests that correlate to at least one other test, the reporting component 206 may also be configured to recommend a particular test to retain from a set of correlated tests that are candidates for removal (926). The recommendations for retention or removal may be selected according to any appropriate rules 928 or other criteria. For example, the retention or removal recommendations may be selected to improve test time, ensure reliability, manual selection, or any other appropriate method.

The recommendation engine 324 of the present embodiment may make recommendations for test retention and removal according to a set of recommendation rules and a set of historical recommendations. The recommendation engine 324 may initially select a test having a favorable state code for retention, and recommend removal of the remaining tests. If the tests all have the same state code, the reporting component suitably recommends removal of all of the correlated tests that are removal candidates except for the test having the lowest PCI. Recommmendations may be made according to any appropriate criteria, however, such as the shortest execution time or any other appropriate characteristics or criteria.

The reporting component 206 may provide the recommendations and any other output in any appropriate format or form. For example, the reporting component 206 may generate an electronic report 330 identifying the various tests and the recommendations for removal, full testing, corrective action, and the like. In addition, the reporting component 206 may provide supporting data, such as pass/fail information, correlation charts, pareto charts, trend charts, plots, comparative box plots, histograms, raw test data for the test, summary statistics relating to the test, or any other appropriate information.

The reporting component 206 may also provide additional suggestions or corrections. For example, the reporting component 206 may provide an improved test sequence according to the characteristics of the tests, such as relative failure rates and test interdependencies. In the present embodiment, the reporting component 206 identifies tests that are more likely to be failed or tests that may indicate a failure later in the test process and may recommend placement earlier in the test sequence. Thus, failing parts may be detected earlier in the test process and may facilitate abbreviated testing, thus reducing overall test time.

The results from the recommendation engine 324 may also be provided to other components of the system for other automatic responses 336. For example, the system may include components for automatically revising the test process, removing tests that are removal candidates, changing the sequence of the test process, and the like.

The particular implementations shown and described are illustrative of the invention and its best mode and are not intended to otherwise limit the scope of the present invention in any way. Indeed, for the sake of brevity, conventional signal processing, data analysis, and other functional aspects of the system may not be described in detail. Furthermore, the connecting lines shown in the various figures are intended to represent exemplary functional relationships and/or physical couplings between the various elements. Many alternative or additional functional relationships or physical connections may be present in a practical system.

The present invention has been described above with reference to a preferred embodiment. However, changes and modifications may be made to the preferred embodiment without departing from the scope of the present invention. These and other changes or modifications are intended to be included within the scope of the present invention, as expressed in the following claims.

1. A method of enhancing a test process for implementing multiple tests on a device based on a raw set of test data, comprising:
classifying the tests according to at least one of a characteristic value associated with the test data and a correlation between at least two of the tests; and
modifying the test process in conjunction with the classifying of the tests.

2. A method of enhancing a test process according to claim 1, further comprising filtering the raw set of test data to form a filtered set of test data.

3. A method of enhancing a test process according to claim 2, wherein filtering the raw set of test data comprises:
identifying at least one of an outlier and a missing datum in the raw set of test data; and
removing the at least one of the outlier and the missing datum from the raw set of test data.

4. A method of enhancing a test process according to claim 1, wherein:
classifying the tests comprises identifying a correlation between at least two of the tests; and
modifying the test process includes deleting at least one of the correlated tests from the test process.

5. A method of enhancing a test process according to claim 4, wherein identifying a correlation between at least two of the tests comprises:
analyzing the raw set of test data for a correlation between at least two of the tests; and
analyzing the filtered set of test data for a correlation between at least two of the tests.

6. A method of enhancing a test process according to claim 1, further comprising:
generating a raw characteristic value based on the raw set of test data; and
generating a filtered characteristic value based on the filtered set of test data, wherein classifying the tests includes classifying the tests according to at least one of the raw characteristic value and the filtered characteristic value.

7. A method of enhancing a test process according to claim 1, further comprising making recommendations for enhancing the test process according to the classification of the tests.

8. A method of enhancing a test process according to claim 1, wherein the characteristic value comprises a process capability index.

9. A method of enhancing a test process according to claim 8, wherein the process capability index is based on at least one of a maximum test data value relative to a threshold and a minimum test data value relative to a threshold.

10. A method of enhancing a test process according to claim 1, wherein classifying the tests comprises classifying the tests according to a set of rules selected from multiple sets of rules.

11. A method of enhancing a test process for implementing multiple tests on a device based on a raw set of test data, comprising:
filtering the raw set of test data to form a filtered set of test data;
generating a characteristic value based on at least one of the raw set of test data and the filtered set of test data;
identifying a correlation between at least two of the tests based on at least one of the raw set of test data and the filtered set of test data;
classifying the tests according to the characteristic value and the correlation between at least two of the tests; and
recommending enhancements to the test process according to the classification of the tests.

12. A method of enhancing a test process according to claim 11, wherein filtering the raw set of test data comprises:
identifying at least one of an outlier and a missing datum in the raw set of test data; and
removing the at least one of the outlier and the missing datum from the raw set of test data.

13. A method of enhancing a test process according to claim 11, further comprising deleting at least one of the correlated tests from the test process.

14. A method of enhancing a test process according to claim 11, wherein identifying a correlation between at least two of the tests comprises:
analyzing the raw set of test data for a correlation between at least two of the tests; and
analyzing the filtered set of test data for a correlation between at least two of the tests.

15. A method of enhancing a test process according to claim 11, wherein:
generating a characteristic value comprises:
generating a raw characteristic value based on the raw set of test data; and
generating a filtered characteristic value based on the filtered set of test data; and
classifying the tests includes classifying the tests according to at least one of the raw characteristic value and the filtered characteristic value.

16. A method of enhancing a test process according to claim 11, wherein the characteristic value comprises a process capability index.

17. A method of enhancing a test process according to claim 16, wherein the process capability index is based on at least one of a maximum test data value relative to a threshold and a minimum test data value relative to a threshold.

18. A method of enhancing a test process for implementing multiple tests on a device, comprising:
receiving a raw set of test data from a data source;
generating a raw characteristic value derived from the raw set of data;
identifying at least one of an outlier, a failure, and a missing datum in the raw set of test data;
removing the at least one of the outlier, the failure, and the missing datum from the raw set of test data to form a filtered set of test data;
generating a filtered characteristic value derived from the filtered set of test data;
identifying a first correlation value between at least two tests based on the raw set of test data;
identifying a second correlation value between at least two tests based on the filtered set of test data;
classifying the tests according to at least one of the raw characteristic value, the outlier, the filtered characteristic value, the missing datum, the failure, the first correlation, and the second correlation;
making recommendations for enhancing the test process according to the classification of the tests; and
modifying the test process in conjunction with the recommendations.

19. A method of enhancing a test process according to claim 18, wherein classifying the tests comprises:
comparing the raw characteristic value to a first threshold;
comparing the filtered characteristic value to a second threshold;
comparing the first correlation value to a raw correlation threshold; and
comparing the second correlation value to a filtered correlation threshold.

20. A method of enhancing a test process according to claim 18, wherein modifying the test process comprises removing a first test if at least one of the first correlation value and the second correlation value compares favorably to a correlation threshold.

21. A method of enhancing a test process according to claim 18, wherein making recommendations includes recommending sampling for the test if at least one of the raw characteristic value compares favorably to the raw threshold and the filtered characteristic value compares favorably to the filtered threshold.

22. An enhancement system for enhancing a test process having multiple tests based on a raw set of test data, comprising:
a calculation component configured to calculate a characteristic value based on the raw set of test data;
a correlation component configured to identify a correlation between at least two tests of the test process; and
a classifying component configured to classify at least one of the tests based on at least one of the characteristic value and the correlation.

23. An enhancement system according to claim 22, further comprising a reporting component configured to recommend a modification of the test process according to the classification of the at least one of the tests.

24. An enhancement system according to claim 22, further comprising a filter configured to filter at least one of an outlier and a missing datum from the raw set of test data to form a filtered set of test data.

25. An enhancement system according to claim 24, wherein the calculation component is configured to calculate a filtered characteristic value based on the filtered set of test data.

26. An enhancement system according to claim 25, wherein the classifying component is configured to classify the at least one of the tests based on the raw characteristic value, the filtered characteristic value, and the correlation.

27. An enhancement system according to claim 24, wherein the filter identifies the outlier by comparing the outlier to a dynamic outlier threshold.

28. An enhancement system according to claim 22, wherein the classifying component is configured to:
compare the characteristic value to a threshold; and
classify the test according to the comparison.

29. An enhancement system according to claim 22, wherein the characteristic value comprises at least one of a Cpk, a PCI, and a preselected value.

30. An enhancement system for enhancing a test process having multiple tests, comprising:
an analysis component configured to identify a correlation between at least two of the tests based on a raw set of test data; and
a reporting component configured to recommend modifications to the test process according to the correlation.

31. An enhancement system according to claim 30, wherein the reporting component is configured to recommend deletion of at least one of the tests subject to the correlation.

32. An enhancement system according to claim 30, further comprising an acquisition component configured to generate a characteristic value based on a raw set of test data generated in conjunction with the test process.

33. An enhancement system according to claim 30, further comprising a filter configured to filter the raw set of test data to form a filtered set of test data.

34. An enhancement system according to claim 33, wherein the filter is configured to:
identify an outlier in the raw set of test data; and
remove the outlier from the raw set of test data to form a filtered set of data.

35. An enhancement system according to claim 34, wherein the analysis component is configured to:
analyze the raw set of test data for a correlation between at least two of the tests; and
analyze the filtered set of test data for a correlation between at least two of the tests.

36. An enhancement system according to claim 34, wherein the analysis component is configured to:
generate a raw characteristic value based on the raw set of test data;
generate filtered characteristic value based on the filtered set of test data; and
classify the tests according to at least one of the raw characteristic value and the filtered characteristic value.

37. An enhancement system according to claim 30, wherein the analysis component is configured to operate in conjunction with a set of rules, wherein the set of rules is selected from a library having multiple sets of predefined rules.

38. A testing system for testing devices using an enhanced test process, comprising:
a tester configured to test the devices using multiple tests and generate a raw set of test data; and
a test enhancement system, comprising:
an analysis component configured to identify a correlation between at least two of the tests based on a raw set of test data; and
a reporting component configured to recommend modifications to the test process according to the correlation.

39. A testing system according to claim 38, wherein the reporting component is configured to recommend deletion of at least one of the tests subject to the correlation.

40. A testing system according to claim 38, further comprising an acquisition component configured to generate a characteristic value based on a raw set of test data generated in conjunction with the test process wherein the acquisition component.

41. A testing system according to claim 38, further comprising a filter configured to filter the raw set of test data to form a filtered set of test data.

42. A testing system according to claim 41, wherein the filter is configured to:
identify an outlier in the raw set of test data; and
remove the outlier from the raw set of test data to form a filtered set of data.

43. A testing system according to claim 41, wherein the analysis component is configured to:
analyze the raw set of test data for a correlation between at least two of the tests; and
analyze the filtered set of test data for a correlation between at least two of the tests.

44. A testing system according to claim 41, wherein the analysis component is configured to:
generate a raw characteristic value based on the raw set of test data;
generate filtered characteristic value based on the filtered set of test data; and
classify the tests according to at least one of the raw characteristic value and the filtered characteristic value.

45. A testing system according to claim 38, wherein the analysis component is configured to identify the correlation based on the raw set of test data and a rule, wherein the rule is selected from a library of rules.

46. An enhancement system for enhancing a test process having multiple tests and generating a raw set of test data, comprising:
classifying means for classifying the tests according to at least one of a characteristic value associated with the test data and a correlation between at least two of the tests; and
modifying means for modifying the test process in conjunction with the classifying of the tests.

47. An enhancement system according to claim 46, further comprising filter means for filtering the raw set of test data to form a filtered set of test data.

48. An enhancement system according to claim 47, wherein the classifying means is configured to:
analyze the raw set of test data for a correlation between the at least two of the tests; and
analyze the filtered set of test data for the correlation between the at least two of the tests.

49. An enhancement system according to claim 47, wherein the classifying means comprises:
raw calculating means for generating a raw characteristic value based on the raw set of test data; and
generating a filtered characteristic value based on the filtered set of test data, wherein classifying the tests includes classifying the tests according to at least one of the raw characteristic value and the filtered characteristic value.

50. An enhancement system according to claim 46, wherein the filter means comprises:
identifying means for identifying at least one of an outlier and a missing datum in the raw set of test data; and
removing means for removing the at least one of the outlier and the missing datum from the raw set of test data.

51. An enhancement system according to claim 46, wherein:
the classifying means includes correlation means for identifying a correlation between at least two of the tests; and
the modifying means is configured to delete at least one of the correlated tests from the test process.

52. An enhancement system according to claim 46, further comprising recommendation means for making recommendations to enhance the test process according to the classification of the tests.

53. An enhancement system according to claim 46, further comprising recommendation means for making recommendations to reduce a test time of the test process according to the classification of the tests.

54. A method of enhancing a test process, comprising:
automatically analyzing a plurality of test results to generate a test analysis result; and
adjusting the test process in accordance with the test analysis result.

55. A method of enhancing a test process according to claim 54, wherein automatically analyzing the plurality of test results comprises:
classifying a plurality of tests according to at least one of a characteristic value associated with the test results and a correlation between at least two of the tests; and
modifying the test process in conjunction with the classifying of the tests.

56. A method of enhancing a test process according to claim 55, wherein the characteristic value comprises a process capability index.

57. A method of enhancing a test process according to claim 56, wherein the process capability index is based on at least one of a maximum test data value relative to a threshold and a minimum test data value relative to a threshold.

58. A method of enhancing a test process according to claim 55, wherein:
classifying the tests comprises identifying a correlation between at least two of the tests; and
modifying the test process includes deleting at least one of the correlated tests from the test process.

59. A method of enhancing a test process according to claim 58, wherein classifying the tests comprises classifying the tests according to a set of rules selected from multiple sets of rules.

60. A method of enhancing a test process according to claim 58, wherein identifying a correlation between at least two of the tests comprises:
analyzing the raw set of test data for a correlation between at least two of the tests; and
analyzing the filtered set of test data for a correlation between at least two of the tests.

61. A method of enhancing a test process according to claim 54, further comprising filtering the test results to form a filtered set of test data.

62. A method of enhancing a test process according to claim 61, wherein filtering the raw set of test data comprises:
identifying at least one of an outlier and a missing datum in the raw set of test data; and
removing the at least one of the outlier and the missing datum from the raw set of test data.

63. A method of enhancing a test process according to claim 61, further comprising:
generating a raw characteristic value based on the test results; and
generating a filtered characteristic value based on the filtered set of test data, wherein classifying the tests includes classifying the tests according to at least one of the raw characteristic value and the filtered characteristic value.

64. A method of enhancing a test process according to claim 54, further comprising making recommendations for enhancing the test process according to the classification of the tests.

65. A test enhancement system for enhancing a test process, comprising:
an analysis component configured to automatically analyze a plurality of test results to generate an analysis result; and
a reporting component configured to report the analysis result.

66. A test enhancement system according to claim 65, wherein the analysis component is configured to identify a correlation between at least two tests based on the test results.

67. A test enhancement system according to claim 66, wherein the reporting component is configured to recommend modifications to the test process according to the correlation.

68. A test enhancement system according to claim 67, wherein the reporting component is configured to recommend deletion of at least one of the tests subject to the correlation.

69. A test enhancement system according to claim 65, further comprising an acquisition component configured to generate a characteristic value based on the test results.

70. A test enhancement system according to claim 65, further comprising a filter configured to filter the test results to form a filtered set of test data.

71. A test enhancement system according to claim 70, wherein the filter is configured to:
identify an outlier in the raw set of test data; and
remove the outlier from the raw set of test data to form a filtered set of data.

72. A test enhancement system according to claim 71, wherein the analysis component is configured to:
analyze the test reulsts for a correlation between at least two tests; and
analyze the filtered set of test data for a correlation between at least two of the tests.

73. A test enhancement system according to claim 70, wherein the analysis component is configured to:
generate a raw characteristic value based on the test results;
generate filtered characteristic value based on the filtered set of test data; and
classify the tests according to at least one of the raw characteristic value and the filtered characteristic value.

74. A test enhancement system according to claim 65, wherein the analysis component is configured to operate in conjunction with a set of rules, wherein the set of rules is selected from a library having multiple sets of predefined rules.
